(19) United States
(12) Patent Application Publication
(10) Pub. No.: US 2022/0393163 A1
(43) Pub. Date: Dec. 8, 2022

(54) LITHIUM-ION BATTERY WITH SCANDIUM DOPING FOR CATHODE, ANODE, AND ELECTROLYTE MATERIALS

(71) Applicant: Scandium International Mining Corporation, Sparks, NV (US)

(72) Inventor: Willem P.C. Duyvesteyn, Reno, NV (US)

(21) Appl. No.: 17/339,924

(22) Filed: Jun. 4, 2021

(51) Int. Cl. H01M 4/525; H01M 10/0525; H01M 4/505

(52) U.S. Cl. CPC H01M 4/525; H01M 10/0525; H01M 4/505

(57) ABSTRACT

A lithium ion battery is provided which includes an LTO anode; an LNMO cathode; and an electrolyte. At least one of the cathode, anode and electrolyte is Sc doped. The cathode may have a composition within the range of LiNi_{0.5}Mn_{1.495}Sc_{0.005}O₄ to LiNi_{0.5}Mn_{1.25}Sc_{0.25}O₄ or, in some embodiments, LiNi_{0.5}Mn_{1.495}Sc_{0.005(1-0.01y)}X_{0.005(0.01y)}O₄, wherein 0≤y≤50, and wherein X is one or more metals selected from the group consisting of yttrium, cerium, niobium and zirconium. The anode may have a composition within the range of Li₄Ti_{4.99}Sc_{0.01}O₁₂ to Li₄Ti_{4.95}Sc_{0.05}O₁₂ or, in some embodiments, Li₄Ti_{4.995}Sc_{0.005(1-0.01y)}X_{0.005(0.01y)}O₁₂ to Li₄Ti_{4.995}Sc_{0.25(1-0.01y)}X_{0.25(0.01y)}O₁₂, wherein 0≤y≤50, and wherein X is one or more metals selected from the group consisting of yttrium, cerium, niobium and zirconium.

### CROSS-REFERENCE TO RELATED APPLICATION

This application claims the benefit of priority from U.S. provisional application No. 63/303,930, filed Jun. 4, 2020, having the same inventor, and the same title, and which is incorporated herein by reference in its entirety.

### FIELD OF THE DISCLOSURE

The present disclosure relates generally to lithium ion batteries, and more specifically to lithium ion batteries with scandium-doped cathode, anode and/or electrolyte materials.

### BACKGROUND OF THE DISCLOSURE

Rechargeable lithium ion batteries (LIBs) are a staple of everyday life. As seen in FIG. 1, these devices 101 comprise a separator 103 and two electrodes (an anode 105 and a cathode 107) which are in electrical contact with each other by way of an electrolyte 109. During charging and discharging, lithium ions 111 within the LIB 101 migrate back and forth between the electrodes 105, 107 via the electrolyte 109, which is typically a lithium salt (such as, for example, LiPF₆) disposed in an organic solvent. Additives are commonly added to the electrolyte 109 to improve performance, enhance stability, prevent solution degradation and prevent the formation of lithium dendrites.

Considerable effort is being expended in developing next-generation materials for LIBs that will make these batteries safer, lighter, more durable, faster to charge, more powerful, and more cost-effective than existing LIBs. A significant portion of this effort has focused on developing and optimizing cathode materials that eliminate cobalt, thereby addressing ethical and supply issues related to artisanal cobalt mining in Africa. Lithium nickel manganese oxide (LNMO, or LiNi_{0.5}Mn_{1.5}O₄) has emerged as one promising cathode material for next generation lithium-ion batteries.

LNMO cathode chemistry has numerous advantages in LIBs. LMNO provides high working potentials and high energy densities, thus resulting in longer operating ranges and/or reduced battery size. The three-dimensional spinel structure of LNMO also permits high discharge rates and fast battery charging. Moreover, due to the absence in LMNO of cobalt and its relatively low nickel content, LMNO is a cost-effective alternative to other LIB chemistries.

### SUMMARY OF THE DISCLOSURE

In one aspect, a lithium ion battery is provided which comprises an LTO anode; an LNMO cathode; and an electrolyte. At least one of said cathode, said anode and said electrolyte is Sc doped. The cathode may have a composition within the range of LiNi_{0.5}Mn_{1.495}Sc_{0.005}O₄ to LiNi_{0.5}Mn_{1.25} Sc_{0.25}O₄ or, in some embodiments, LiNi_{0.5}Mn_{1.495}Sc_{0.005(1-0.01y)}X_{0.005(0.01y)}O₄, wherein 0≤y≤50, and wherein X is one or more metals selected from the group consisting of yttrium, cerium, niobium and zirconium. The anode may have a composition within the range of Li₄Ti_{4.99}Sc_{0.01}O₁₂ to Li₄Ti_{4.95}Sc_{0.05}O₁₂ or, in some embodiments, Li₄Ti_{4.995}Sc_{0.005(1-0.01y)}X_{0.005(0.01y)}O₁₂ to Li₄Ti_{4.995}Sc_{0.25(1-0.01y)}X_{0.25(0.01y)}O₁₂, wherein 0≤y≤50, and wherein X is one or more metals selected from the group consisting of yttrium, cerium, niobium and zirconium. The electrolyte is preferably a solid-state electrolyte and may be a perovskite. The electrolyte preferably utilizes scandium doping for atomic-scale grain-boundary modification to improve macroscopic Li⁺ conductivity.

### BRIEF DESCRIPTION OF THE DRAWINGS

FIG. 1 is an illustration of a conventional lithium ion battery.

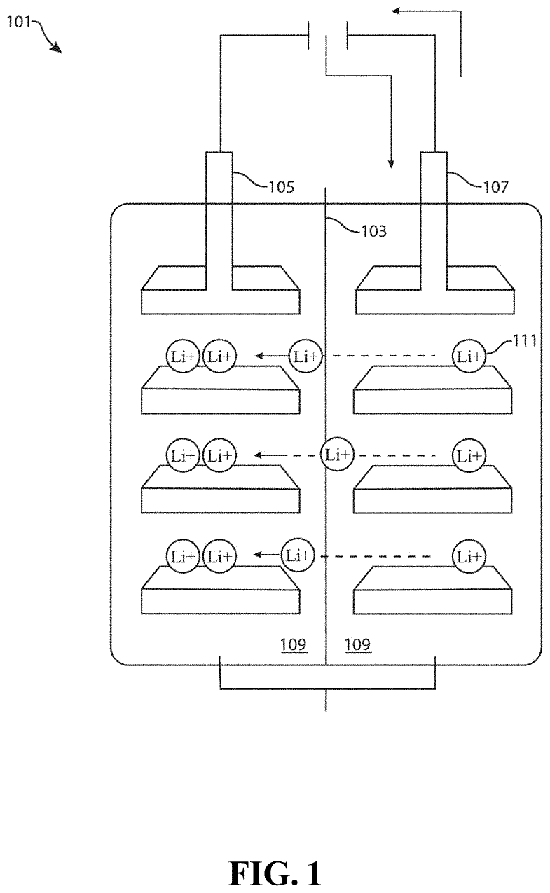

FIG. 2 is an illustration of some temperature-induced issues which are problematic for lithium ion batteries.

FIG. 3 is an illustration of the perovskite crystal structure.

FIG. 4 is an illustration of the atomic-scale grain-boundary modification.

### DETAILED DESCRIPTION

Unfortunately, despite the many advantages LMNO cathode chemistry confers, LNMO-based batteries have yet to reach their full performance potential. One reason for this is the lack of a suitable electrolyte that can be used in conjunction with LMNO cathodes. In particular, conventional electrolytes are unable to handle the high voltages that LNMO-based batteries operate at without becoming degraded over time, a process which ultimately renders the battery useless.

In this respect, it is to be noted that most lithium ion batteries (LIBs) have a liquid electrolyte that typically consists of one or more lithium compounds dissolved in an organic solvent medium. The lithium compounds are typically electrically conducting lithium salts (such as, for example, LiClO₄, LiAsF₆, LIBF₄, LiPF₆), and the solvent medium typically includes cyclic and acyclic carbonates (such as, for example, ethylene carbonate (EC), propylene (PC), diethyl carbonate (DEC), and ethyl methyl carbonate (EMC)). The electrolyte transports lithium ions between the cathode and the anode, with the direction of travel depending on whether the battery is in a recharge cycle or a discharge cycle.

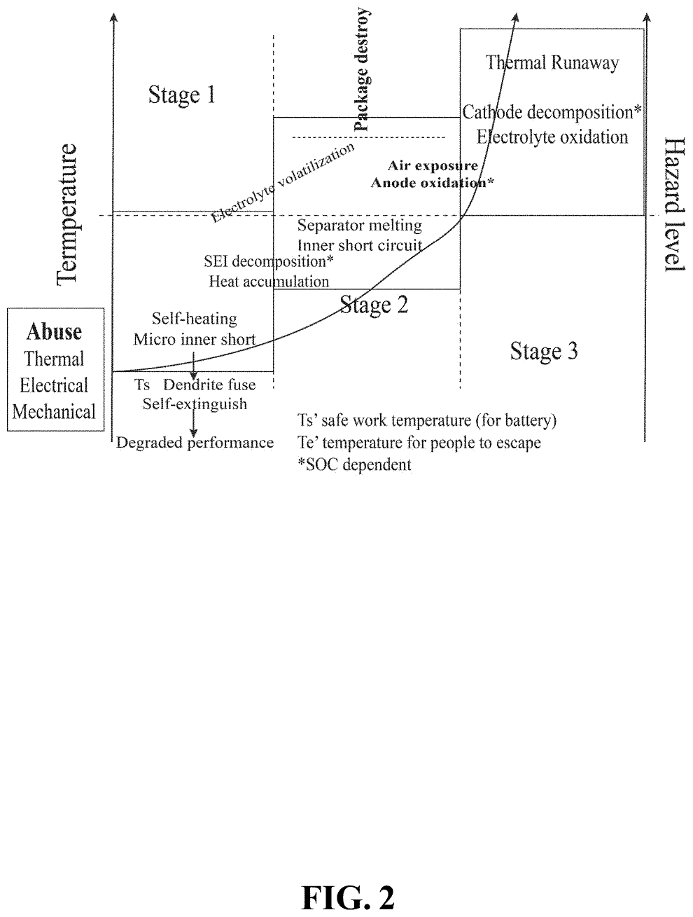

It is desirable that the solvents in the LIB remain anodically and cathodically stable during the discharge or recharge cycle. However, in practice, this is challenging to achieve, since these solvents are thermodynamically unstable in the presence of lithium or LiₓC₆ (this represents the anode with lithium intercalated in the graphite sheets) in the operating potential range. As a result, the liquid electrolyte is usually flammable and hazardous, and also typically represents a significant cost/weight penalty in the design of the battery. As a result of these and other problems (some of which are summarized in FIG. 2), there is an ongoing need in the art for improvements to electrolytes that are less expensive and provide higher energy densities.

On the anode side on the LIB, carbonaceous materials are being replaced by a different lithium nickel spinel: LTO or Li₄Ti₅O₁₂. The use of LTO is advantageous in that it offers a flat and high potential at about 1.55 V, a high thermal and structural stability, and limited volume change during cycling. It is also an inherently safe material. Unfortunately, the low electronic conductivity and lithium ion diffusion coefficient of LTO significantly hinders its application at high charge-discharge rates.

It has now been found that the electrochemical limitations (and associated crystal stresses) in the spinel materials of current LNMO and LTO cathodes and anodes may be improved significantly through selective doping. In particular, a partial and small replacement of the Ni in the LNMO cathode, and the Ti in the LTO anode, may be utilized to overcome some or all of the foregoing issues. Such doping may be with scandium alone, or with scandium and one or more elements selected from the group consisting of yttrium, cerium, niobium and zirconium. Examples of such doping may result in a doped LNMO cathode consisting of, for example, LiNi_{0.5}Mn_{1.455}Sc_{0.045}O₄, and in a doped LTSO anode consisting of Li₄Ti_{4.95}Sc_{0.05}O₁₂ with scandium ranging from as low as 0.005 to as high as 0.25.

Without wishing to be bound by theory, it is believed that the degradation of electrolytes experienced with existing LNMO cathodes in LIBs is, to a large extent, caused by the cycling of Mn between the 4+ and 3+ valence states. The foregoing doping may prevent this from happening, thus overcoming electrolyte degradation and obviating the need for the development of new electrolyte materials. Meanwhile, Sc doping of LTO cathodes may improve the performance of these materials by improving their electronic conductivity and reducing the lithium ion diffusion coefficient of LTO. It will thus be appreciated that Sc doping (possibly in combination with other metal dopants such as, for example, yttrium, cerium, niobium and zirconium) may be utilized to improve the performance of lithium ion batteries based on LNMO cathodes and/or LTO anodes.

The amount of Sc doping may vary, and in some embodiments and applications, a portion of the Sc content may be replaced by other metals such as, for example, yttrium, cerium, niobium and zirconium. In LNMO cathode materials, the Sc doping is preferably in the range of from about 0.1% to about 5% (or from LiNi_{0.5}Mn_{1.495}Sc_{0.005}O₄ to LiNi_{0.5}Mn_{1.25}Sc_{0.25}O₄). In LTO anode materials, the Sc doping is preferably used to obtain a composition within the range of Li₄Ti_{4.99}Sc_{0.001}O₁₂ to Li₄Ti_{4.95}Sc_{0.05}O₁₂. Substitution of Sc with yttrium, cerium, niobium and/or zirconium may amount to about 10% to about 50% of the contained scandium in the foregoing cathode or anode materials.

It has also been found that the issues with respect to existing liquid electrolytes in LIBs may be overcome through the use of scandium-doped, highly conductive solid electrolyte materials (that is, through the provision of a scandium-doped solid state electrolyte (SSE) battery). Since SSE batteries lack a flammable liquid electrolyte, they offer significant safety advantages and avoid issues with thermal runaway. They also provide high energy densities, excellent cycling stability and excellent shelf life, while avoiding some or all of the safety provisions required in conventional LIBs equipped with liquid electrolytes. On the other hand, SSE batteries are often characterized by slower kinetics due to low ionic conductivities, high interfacial resistances and poor interfacial contact.

SSEs may be equipped with dry polymer electrolytes, gel polymer electrolytes or inorganic or ceramic solid electrolytes. In the case of the latter, the ceramic solids utilized in the electrolyte typically have one of the compositions depicted in TABLE 1 below.

TABLE 1
Typical Ceramic Solids for LIBs

| Classification | Materials |
|---|---|
| Anti-perovskite | Li_{2.99}Ba_{0.005}OCl₁₋ₓ(OH)ₓ |
| | Li₃OCl |
| Perovskite-type | Li_{0.34}La_{0.556}TiO₃ |
| | Li_{0.15}La_{0.28}TaO₃ |
| Garnet-type | Lᵢ₇La₃Zr₂O₁₂ |
| | Lᵢ₅La₃Ta₂O₁₂ |
| | Lᵢ₇La₃Nb₂O₁₂ |
| NASICON | Li_{1.5}Al_{0.5}Ge_{1.5}(PO₄)₃ |
| | Li_{1.4}Al_{0.4}Ti_{1.6}(PO₄)₃ |
| | LiZr₂(PO₄)₃ |
| Thio-LISICON | Li_{3.5}Si_{0.5}P_{0.5}O₄ |
| LISICON | Li₁₂Zn(GeO₄)₄ |

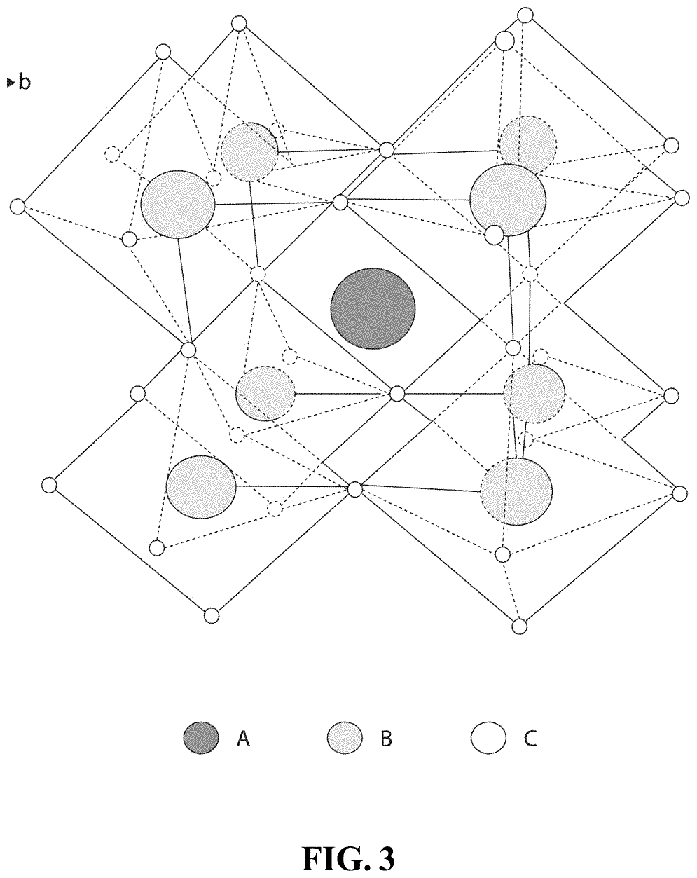

As will be appreciated from TABLE 1, one class of these ceramic solid electrolytes are perovskites (and its sister compounds garnets) with the general formula of ABO₃ and A₃B₂C₃O₁₂. Some typical examples of perovskites (and their properties and applications) are set forth in TABLE 2 below. The perovskite crystal structure is depicted in FIG. 3. LLTO (perovskite: Li₃ₓLa_{2/3-x}TiO₃) and LLZO (garnet: Li₇La₃Zr₂O₁₂) are high conductivity electrolytes that are commonly used in LIBs.

TABLE 2
Physical Properties of Some Compounds Exhibiting Perovskite
Type Structures

| | | Possible or |
|---|---|---|
| Composition | Physical Property | Present Application |
| CaTiO₃ | Dielectric | Microwave applications |
| BaTiO₃ | Ferroelectric | Non-volatile computer |
| | | memories |
| PbZr₁₋ₓTiₓO₃ | Piezoelectric | Sensors |
| Ba₁₋ₓLaₓTiO₃ | Semiconductor | Semiconductor applications |
| Y_{0.33}Ba_{0.67}CuO₃₋ₓ | Superconductor | Magnetic signal detectors |
| (Ln, Sr)CoO₃₋ₓ | Mixed ionic and | Gas diffusion membranes |
| | electronic conductor | |
| BaInO_{2.5} | Ionic conductor | Electrolyte in solid oxide |
| | | fuel cells |
| AMnO₃₋ₓ | Giant magneto | Read heads for hard disks |
| | resistance | |

Generally speaking, the electrochemical parameters of any perovskite or garnet compound that contains Y, Ti, Zr, Ta, or Nb may be improved by partial replacement of these elements (aka doping) with scandium. LLTO (perovskite: Li₃ₓLa_{2/3-x}TiO₃) and LLZO (garnet: Li₇La₃Zr₂O₁₂) are typical examples of high conductivity electrolytes that are used in LIBs.

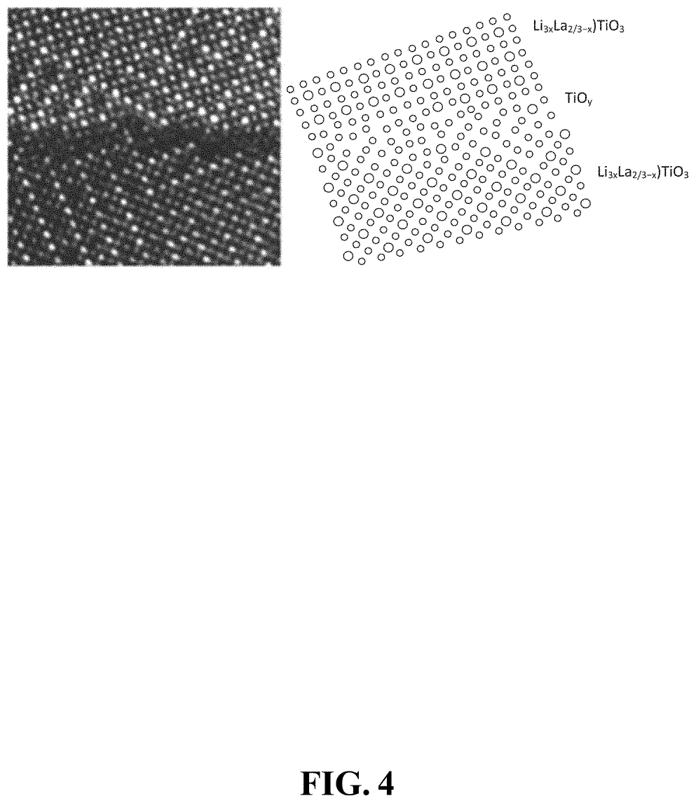

Although Li-ion-conducting solid electrolytes represent a potential solution to the significant safety issues attendant to the use of solvent-based electrolytes in conventional batteries, the ionic conductivity of solid electrolytes is typically too low for this application. This is believed to be due to high grain-boundary (GB) resistance. In particular, structural and chemical deviations of about 2-3 unit cells thick have been found at the grain boundaries in perovskite materials such as (Li₃ₓLa_{2/3-x})TiO₃ (see FIG. 4). Instead of preserving the ABO₃ perovskite framework, such GBs have been found to consist of a binary Ti—O compound, which prohibits the abundance and transport of charge carriers (Li⁺). See, e.g., Ma, Cheng & Chen, Kai & Liang, Chengdu & Nan, C. W. & Ishikawa, Ryo & More, Karren & Chi, Miaofang, “Atomic-Scale Origin of the Large Grain-Boundary Resistance in Perovskite Li-Ion-Conducting Solid Electrolytes”, Energy & Environmental Science, 7, 1638, 10, (2014) 1039/c4ee00382a.

It has now been found that the foregoing problem may be addressed by doping LLTO with scandium (between 0.1 and 5% Sc) and by replacing a portion of the titanium at the GB with scandium. Thus, for example, after such doping, Li₃ₓLa_{2/3-x})TiO₃ has a composition from (Li₃ₓLa_{2/3-x})Ti_{0.99} Sc_{0.01}O₃ to (Li₃ₓLa_{2/3-x})Ti_{0.95}Sc_{0.05}O₃.

Here, it is noted that some scandium doping of garnet-structured Li₇La₃Zr₂O₁₂ has been reported in the literature, albeit with co-doping of gallium. This material is particularly promising as a solid electrolyte, due to its wide electrochemical stability window. However, the ionic conductivity of this material is still an order of magnitude lower than that of common liquid electrolytes. A dual substitution strategy has been utilized to enhance Li-ion mobility in garnet-structured solid electrolytes whereby a first dopant cation (Ga³⁺) is introduced on the Li sites to stabilize the fast-conducting cubic phase, while simultaneously, a second cation (Sc³⁺) is used to partially populate the Zr sites. This approach increases the concentration of Li ions by charge compensation, and allows fine-tuning of the number of charge carriers in the cubic Li₇La₃Zr₂O₁₂ according to the resulting stoichiometry (Li_{7-3x+y}GaₓLa₃Zr_{2-y}Sc_{y}O₁₂). The existence of both Ga and Sc cations in the garnet structure results in a particular cationic distribution in Li_{6.65}Ga_{0.15}La₃Zr_{1.90}Sc_{0.10}O₁₂, such that Ga³⁺ preferentially occupies tetrahedral Li_{24d} sites over the distorted octahedral Li₉₆ₕ sites. Analysis of the structure with ⁷Li NMR reveals a heterogeneous distribution of Li charge carriers with distinct mobilities. This unique Li local structure improves the transport properties of the garnet by enhancing its ionic conductivity and lowering its activation energy. See Lucienne Buannic, Brahim Orayech, Juan-Miguel López Del Amo, Javier Carrasco, Nebil A. Katcho, Frederic Aguesse, William Manalastas, Wei Zhang, John Kilner, and Anna Llordés, “Dual Substitution Strategy to Enhance Li⁺ Ionic Conductivity in Li₇La₃Zr₂O₁₂ Solid Electrolyte”, Chemistry of Materials 2017 29 (4), 1769-1778.

In some applications, it has been shown that, when yttrium is used as a dopant, replacing yttrium for scandium will produce enhanced results. One example of this is in solid oxide fuel cells that utilize yttrium stabilized zirconia. There, attempts have been made to increase the bulk and total conductivity of Li₇La₃Zr₂O₁₂ (LLZ) with partial substitution of trivalent Y for a tetravalent Zr using yttria-stabilized ZrO₂ (3% YSZ) as reactant. The small doping of Y for Zr helps to increase the bulk and total conductivity to 9.56×10−4 and 8.10×10⁻⁴ Scm⁻¹, respectively, at 25° C. The presence of a small amount of Y was found to result in well sintered pellets at relatively lower temperatures with lower sintering time compared to LLZ, which helps to improve the overall conductivity. See Murugan, Ramaswamy & Ramakumar, Sampathkumar & Janani, N. (2011), “High Conductive Yttrium Doped Li₇La₃Zr₂O₁₂ Cubic Lithium Garnet. Electrochemistry Communications”, 13, 1373-1375. This example demonstrated good results in conductivity improvements with the yttrium doping of Li₇La₃Zr₂O₁₂ garnet, with the possibility that even better conductivities may have been achieved by the replacement of yttrium with scandium.

It will be appreciated from the foregoing that scandium doping may be utilized to improve the conductivity and other properties of SSEs. Thus, scandium doping may be utilized to improve any or all of the three main components of LIBs, namely, the cathode, anode and electrolyte.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. In these claims, absent an explicit teaching otherwise, any limitation in any dependent claim may be combined with any limitation in any other dependent claim without departing from the scope of the invention, even if such a combination is not explicitly set forth in any of the following claims.

What is claimed is:

A1. A lithium ion battery, comprising:
an anode;
a cathode; and
an electrolyte;
wherein at least one of said cathode, said anode and said electrolyte is Sc doped.

A2. The lithium ion battery of claim A1, wherein both of said cathode and said anode are Sc doped.

A3. The lithium ion battery of claim A1, wherein said electrolyte is Sc doped.

A4. The lithium ion battery of claim A1, wherein said cathode comprises Sc-doped LNMO which contains about 0.1% to about 5% Sc.

A5. The lithium ion battery of claim A1, wherein said cathode has a composition within the range of LiNi_{0.5}Mn_{1.495}Sc_{0.005}O₄ to LiNi_{0.5}Mn_{1.25} Sc_{0.25}O₄.

A6. The lithium ion battery of claim A1, wherein said cathode has the composition LiNi_{0.5}Mn_{1.495}Sc_{0.0005(1-0.01y)}X_{0.005(0.01y)}O₄, wherein 0≤y≤50, and wherein X is one or more metals selected from the group consisting of yttrium, cerium, niobium and zirconium.

A7. The lithium ion battery of claim A1, wherein said cathode has the composition LiNi_{0.5}Mn_{1.495}Sc_{0.0005(1-0.01y)}X_{0.005(0.01y)}O₄, wherein 10≤y≤50, and wherein X is one or more metals selected from the group consisting of yttrium, cerium, niobium and zirconium.

A8. The lithium ion battery of claim A1, wherein said anode comprises Sc-doped LTO which contains about 0.1% to about 5% Sc.

A9. The lithium ion battery of claim A1, wherein said anode comprises Sc-doped LTO with a composition within the range of Li₄Ti_{4.99}Sc_{0.01}O₁₂ to Li₄Ti_{4.95}Sc_{0.05}O₁₂.

A10. The lithium ion battery of claim A1, wherein said anode comprises Sc-doped LTO with a composition within the range of Li₄Ti_{4.995}Sc_{0.005(1-0.01y)}X_{0.005(0.01y)}O₁₂ to Li₄Ti_{4.995}Sc_{0.25(1-0.01y)}X_{0.25(0.01y)}O₁₂, wherein 0≤y≤50, and wherein X is one or more metals selected from the group consisting of yttrium, cerium, niobium and zirconium.

A11. The lithium ion battery of claim A1, wherein said anode comprises Sc-doped LTO with a composition within the range of Li₄Ti_{4.995}Sc_{0.005(1-0.01y)}X_{0.005(0.01y)}O₁₂ to Li₄Ti_{4.995}Sc_{0.25(1-0.01y)}X_{0.25(0.01y)}O₁₂, wherein 10≤y≤50, and wherein X is one or more metals selected from the group consisting of yttrium, cerium, niobium and zirconium.

A12. The lithium ion battery of claim A1, wherein the electrolyte has a structure selected from the group consisting of perovskite and garnet structures, and wherein the electrolyte is scandium-doped.

A13. The lithium ion battery of claim A12, wherein the electrolyte includes an element selected from the group consisting of Y, Ti, Zr, Ta and Nb, and wherein a portion of the element in the electrolyte has been replaced with Sc.
